(19) United States
(12) Patent Application Publication
(10) Pub. No.: US 2009/0277729 A1
(43) Pub. Date: Nov. 12, 2009

(54) PAD SPRING OF DISC BRAKE AND METHOD FOR MANUFACTURING THE SAME

(76) Inventor: Doe Hee Kim, Gyeonggi-do (KR)

Correspondence Address: LADAS & PARRY, 5670 WILSHIRE BOULEVARD, SUITE 2100, LOS ANGELES, CA, 90036-5679, US

(21) Appl. No.: 12/115,719

(22) Filed: May 6, 2008

(51) Int. Cl. F16D 65/40; B23P 17/00

(52) U.S. Cl. 188/73.38; 29/527.2

(57) ABSTRACT

Disclosed are a pad spring of a disc brake, which guides the sliding motion of pad plates and reduces vibration transmitted from the pad plates to a carrier concurrently, and continuously maintains these functions for a long time, and a method for manufacturing the same. In a pad spring of a disc brake, in which a pair of pad plates sliding towards a disc is accommodated in a carrier fixed to a vehicle frame such that friction pads are respectively attached to the facing inner surfaces of the pad plates so as to press both surfaces of the disc rotated together with the rotation of a wheel and thus fix the disc, and pad springs for guiding the sliding motion of the pad plates and preventing vibration applied to the pad plates from being transmitted to the carrier are interposed among the pad plates and the carrier, one surface of the pad spring contacting the pad plates is coated with a low frictional material and the other surface of the pad spring contacting the carrier is coated with an elastic material.

### BACKGROUND OF THE INVENTION

1. Field of the Invention

The present invention relates to a disc brake, and more particularly, to a pad spring of a disc brake, which guides the sliding motion of pad plates and reduces vibration applied to the pad plates, and a method for manufacturing the same.

2. Description of the Related Art

In general, disc brakes are apparatuses, which forcibly attach friction pads respectively to both side surfaces of a disc, rotating together with the rotation of a wheel of a vehicle, and thus brake and decelerate the vehicle through the frictional force.

Such a disc brake includes a caliper housing having a piston, advancing and retreating by hydraulic brake pressure, therein, a carrier fixed to a vehicle frame and having a pair of pad plates such that friction pads are respectively attached to the facing inner surfaces of the pad plates, and a disc, a portion of the outer circumferential surface of which is inserted into a gap between the pair of the pad plates, rotated together with the rotation of a wheel.

The piston is disposed on the rear portion of the caliper housing so as to push the outer surface of one pad plate toward the disc, and a finger part surrounding the outer surface of the other pad plate is formed on the front portion of the caliper housing in the opposite direction to the piston.

Thus, when the piston is operated such that one pad plate presses one surface of the disc, the other pad plate is guided by the finger part and presses the other surface of the disc. Thereby, the disc is pressed between a pair of the friction pads.

Further, the carrier is fixed to a knuckle of the vehicle frame by a bolt, and the pad plates are slidably installed in the carrier. Pad springs for guiding the sliding motion of the pad plates and suppressing the vibration of the pad plates are provided between the pad plates and the carrier. These pad springs are formed by pressing a metal plate made of stainless steel or spring steel and then bending the metal plate.

The conventional disc brake generate problems, such as loud noise or a difficulty of a smooth sliding motion of the pad plates due to friction caused by direct contact between the pad plates and the pad springs, respectively made of metals, when the pad plates slide so as to press the disc.

In order to solve the above problems, friction planes between the pad plates and the pad springs are coated with grease so as to smoothly carry out the sliding motion of the pad plates and reduce friction noise. However, as time passes, grease tends to gel and thus a designated amount of grease must be frequently added. Further, in the case that abrasion dust generated by the friction between the disc and the friction pads sticks to the friction planes coated with grease, grease cannot exhibit original lubricating performance.

Further, the pad springs elastically support the pad plates and the carrier, and thus absorb vibration, generated by the shaking of the pad plates in the direction perpendicular to the sliding direction during sliding of the pad plates, and prevent the vibration from being transmitted to the carrier. However, as time passes, the elastic deforming and restoring capacities of the pad springs are reduced from the characteristic point of the material of the pad springs, and the above damping function of the pad springs is lowered.

### SUMMARY OF THE INVENTION

Therefore, one aspect of the invention is to provide a pad spring of a disc brake, which guides the sliding motion of pad plates and reduces vibration transmitted from the pad plates to a carrier concurrently, and continuously maintains these functions for a long time, and a method for manufacturing the same.

In accordance with one aspect, the present invention provides a pad spring of a disc brake, in which a pair of pad plates sliding towards a disc is accommodated in a carrier fixed to a vehicle frame such that friction pads are respectively attached to the facing inner surfaces of the pad plates so as to press both surfaces of the disc rotated together with the rotation of a wheel and thus fix the disc, and pad springs for guiding the sliding motion of the pad plates and preventing vibration applied to the pad plates from being transmitted to the carrier are interposed among the pad plates and the carrier, wherein one surface of the pad spring contacting the pad plates is coated with a low frictional material and the other surface of the pad spring contacting the carrier is coated with an elastic material.

The low frictional material may include Teflon.

The low frictional material coated onto the surface of the pad spring may form a thin film having a thickness of 15˜25 μm.

The elastic material may include heat resistant reinforced rubber.

The elastic material may include a synthetic resin, including the heat resistant reinforced rubber and Urethane, carbon black, a vulcanization accelerator, an antioxidant, and a fluorine polymer.

The low frictional material coated onto the surface of the pad spring may form a thin film having a thickness of 25˜35 μm.

In accordance with another aspect, the present invention provides a method for manufacturing a pad spring of a disc brake comprising sanding or corroding both surfaces of a metal plate for forming the pad spring; coating one surface of the sanded or corroded metal plate with a low frictional material and the other surface of the sanded or corroded metal plate with an elastic material; processing the metal plate, coated with the low frictional material and the elastic material, by pressing and bending so as to form a shape of the pad spring; and removing stress, applied to bending regions of the pad spring during the processing of the metal plate, by heat treatment.

In accordance with yet another aspect, the present invention provides a method for manufacturing a pad spring of a disc brake comprising processing a metal plate by pressing and bending so as to form a shape of the pad spring; sanding or corroding both surfaces of the pad spring; coating one surface of the sanded or corroded pad spring with a low frictional material and the other surface of the sanded or corroded pad spring with an elastic material; and removing stress, applied to bending regions of the pad spring during the processing of the metal plate, by heat treatment.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is an exploded perspective view illustrating the structure of a disc brake in accordance with the present invention;

FIG. 2 is a cross-sectional view illustrating an essential portion of the disc brake in accordance with the present invention;

FIG. 3 is an enlarged cross-sectional view illustrating a pad spring of the disc brake in accordance with the present invention;

FIG. 4 is a flow chart illustrating a process for manufacturing a pad spring in accordance with a first embodiment of the present invention; and

FIG. 5 is a flow chart illustrating a process for manufacturing a pad spring in accordance with a second embodiment of the present invention.

### DETAILED DESCRIPTION OF THE PREFERRED EMBODIMENTS

Reference will now be made in detail to the embodiments of the present invention, an example of which is illustrated in the accompanying drawings, wherein like reference numerals refer to like elements throughout. The embodiments are described below to explain the present invention by referring to the annexed drawings.

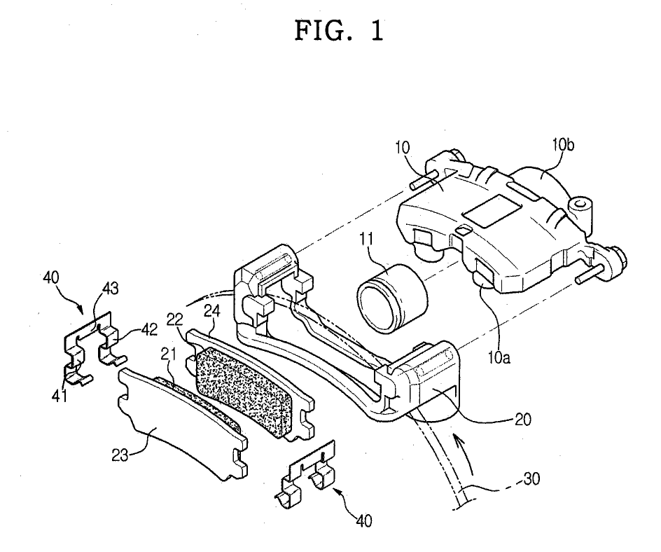

A disc brake in accordance with the present invention, as shown in FIG. 1, includes a caliper housing 10 having a piston 11, advancing and retreating by hydraulic brake pressure, therein, a carrier 20 fixed to a vehicle frame and having a pair of pad plates 23 and 24 such that friction pads 21 and 22 are respectively attached to the facing inner surfaces of the pad plates 23 and 24, and a disc 30, a portion of the outer circumferential surface of which is inserted into a gap between the pair of the pad plates 23 and 24, rotated together with the rotation of a wheel.

The piston 11 is disposed on the rear portion of the caliper housing 10 so as to push the outer surface of one pad plate 24 toward the disc 30, and a finger part 10a surrounding the outer surface of the other pad plate 23 is formed on the front portion of the caliper housing 10 in the opposite direction to the piston 11. The caliper housing 10 is slidably connected to the carrier 20. For the reference, non-described reference numeral 10b represents a cylinder housing the piston 11.

Thus, when the piston 11 is operated such that the pad plate 24 presses one surface of the disc 30, the pad plate 23 is guided by the finger part 10a and presses the other surface of the disc 30. Thereby, the disc 30 is pressed between a pair of the friction pads 21 and 22.

Further, the carrier 20 is fixed to a knuckle of the vehicle frame by a bolt, and the pad plates 23 and 24 are slidably installed in the carrier 20. Pad springs 40 for guiding the sliding motion of the pad plates 23 and 24 and suppressing the vibration of the pad plates 23 and 24 are provided among the pad plates 23 and 24 and the carrier 20.

More specifically, both sides of the carrier 20 and both ends of the pad plates 23 and 24 have protruded and depressed structures corresponding to each other. Each of the pad springs 40 includes a first supporting part 41 supporting one end of the pad plate 23, a second supporting part 42 supporting one end of the pad plate 24, and a connecting part 43 integrally connecting the upper region of the first supporting part 41 and the upper region of the second supporting part 42. Here, the first and second supporting parts 41 and 42, which substantially support the pad plates 23 and 24 and the carrier 20, are bent so as to have protruded and depressed structures corresponding to the shapes of the ends of the pad plates 23 and 24.

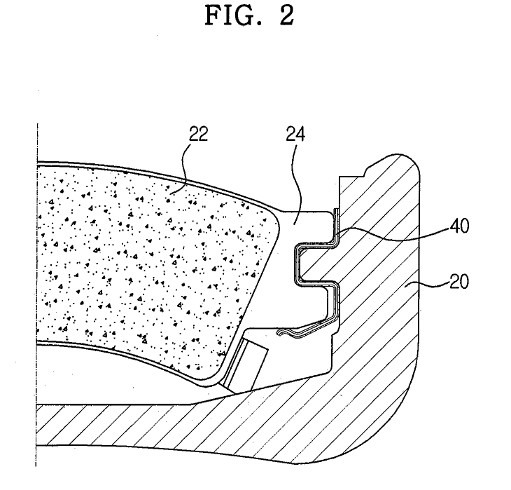

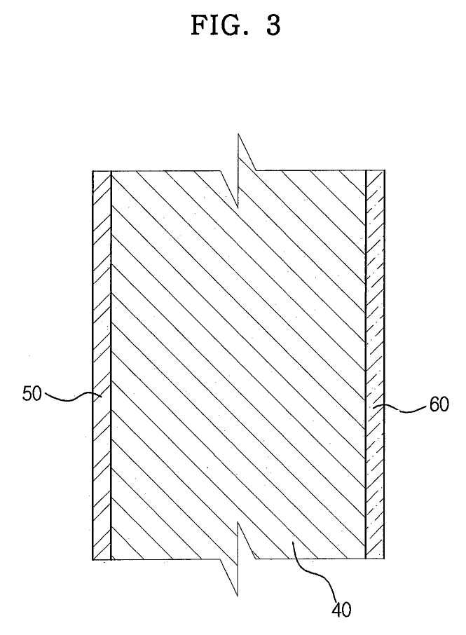

In the present invention, as shown in FIGS. 2 and 3, one surface of the pad spring 40 contacting the pad plates 23 and 24 is coated with a low frictional material 50, and the other surface of the pad spring 40 contacting the carrier 20 is coated with an elastic material 60. Such a structure concurrently improves one function of the pad spring 40 for smoothly guiding the sliding motion of the pad plates 23 and 24 and another function of the pad spring 40 for reducing the vibration transmitted from the pad plates 23 and 24 to the carrier 20, and continuously maintains the improved friction reducing function and damping function of the pad spring 40 for a long time.

That is, when the pad plates 23 and 24 slide so as to press the disc 30, in the case that the pad plates 23 and 24 and the pad spring 40 respectively made of metals contact directly, the friction between the two members causes loud noise and disturbs the smooth sliding motion of the pad plates 23 and 24. However, in this embodiment, under the condition that one surface of the pad spring 40 contacting the pad plates 23 and 24 is coated with the low frictional material 50, the contact friction between the pad plates 23 and 24 and the pad spring 40 is reduced and thus the sliding motion of the pad plates 23 and 24 is more smoothly carried out.

Although the low frictional material 50 is used for a designated time or more, it is not necessary to replace the low frictional material 50 with a new one. Further, although abrasion dust generated by the friction between the disc 30 and the friction pads 21 and 22 sticks to the low frictional material 50, the abrasion dust is naturally removed by wind generated during driving of the vehicle. Thus, it is possible to continuously maintain the smooth sliding motion of the pad plates 23 and 24 for a longer time.

Further, the pad springs 40 elastically support the pad plates 23 and 24 and the carrier 20, and absorb vibration, generated by the shaking of the pad plates 23 and 24 in the direction perpendicular to the sliding direction during sliding of the pad plates 23 and 24, and thus prevent the vibration from being transmitted to the vehicle frame through the carrier 20. As time passes, the elastic deforming and restoring capacities of the pad springs 40 are reduced from the characteristic point of stainless steel or spring steel, and the above damping function of the pad springs 40 may be lowered. However, under the condition that the other surface of the pad spring 40 is coated with the elastic material 60, as described above, the elastic force of the pad spring 40 is doubled through the elastic force of the elastic material 60 and thus the damping function of the pad spring 40 is enhanced. Further, although the elastic force of the pad spring 40 is reduced by the use of the pad spring 40 for a long time, the pad spring 40 can continuously carry out the fundamental damping function due to the elastic force of the elastic material 60.

The low frictional material 50 and the elastic material 60 may be coated locally onto partial regions of the pad springs 40, or be coated uniformly onto the whole regions of both sides of the pad springs 40, as shown in FIG. 3.

Now, a process for manufacturing the pad spring 40 of the present invention will be described.

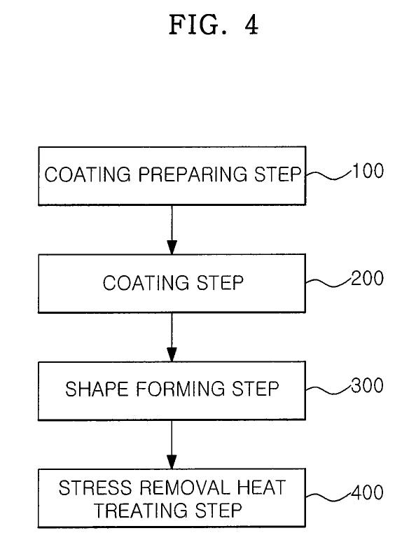

In accordance with a first embodiment, as shown in FIG. 4, the pad spring 40 of the present invention is manufactured through a coating preparing step (100), a coating step (200), a shape forming step (300), and a stress removal heat treating step (400), which are sequentially carried out.

In the coating preparing step (100), both surfaces of a metal plate made of stainless steel or spring steel for forming the pad spring 40 are sanded or corroded such that both the surfaces of the metal plate can be effectively coated with the low frictional material 50 and the elastic material 60. In the coating step (200), both the surfaces of the sanded or corroded metal plate are coated with the low frictional material 50 and the elastic material 60.

Here, Teflon is employed as the low frictional material 50 and heat resistant reinforced rubber and Urethane are employed as the elastic material 60 so as to be able to stand heat of a high temperature in the stress removal heat treating step (400), which will be described later. In the coating step (200), in order to prevent the thickness of the metal plate from excessively increasing, the low frictional material 50 and the elastic material 60 are coated onto the surfaces of the metal plate so as to respectively form thin films having a small thickness. Preferably, the low frictional material 50 has a thickness of 15˜25 μm, and the elastic material 60 has a thickness of 25˜35 μm. Here, the metal plate maintains a thickness of approximately 0.3˜0.5 μm.

Preferably, Teflon employed as the low frictional member 50 is coated onto one surface of the metal plate by spraying. However, Teflon may be coated onto the surface of the metal plate by electrostatic painting or general painting. Further, the elastic material 60 includes a mixture obtained by adding designated amounts of carbon black, a vulcanization accelerator, an antioxidant, and a fluorine polymer to a synthetic resin including heat resistant reinforced rubber and Urethane, and is coated onto the other surface of the metal plate by various methods such as spraying or roller coating.

Here, carbon black serves to increase the heat-resisting property of the elastic material 60 together with the heat resistant reinforced rubber and Urethane, the vulcanization accelerator and the antioxidant serve to increase the elastic force of the heat resistant reinforced rubber and suppress the oxidation of the elastic material 60, and the fluorine polymer serves to accelerate the reaction therebetween.

In the shape forming step (300), the metal plate, went though the coating step (200), has a shape of a pad spring 40 through pressing and bending processes. Stress is concentrated on bending regions, such as the first and second supporting parts 41 and 42, during the bending process. Thus, in the stress removal heat treating step (400), the pad spring 40, went through the shape forming step (300), goes through a heat treatment process, i.e., annealing, at a temperature of 350˜370° C. such that the stress applied in the shape forming step (300) can be removed. Thereby, the manufacture of the pad spring 40 in accordance with the first embodiment is completed. In the above-described process for manufacturing the pad spring 40 in accordance with the first embodiment, the low frictional material 50 and the elastic material 60 are coated on the outer surfaces of the metal plate before the shape of the pad spring 40 is formed, thus being capable of being uniformly coated throughout the whole regions of the surface of the pad spring 40.

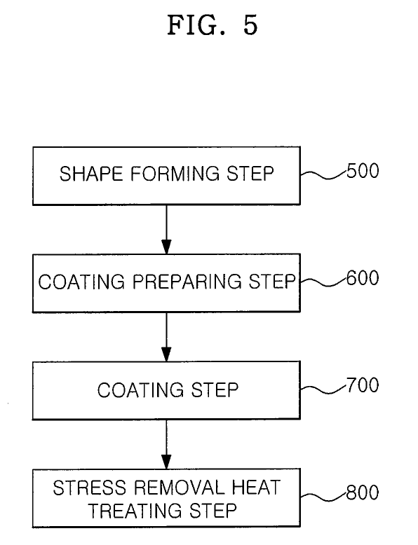

Further, in accordance with a second embodiment, as shown in FIG. 5, the pad spring 40 of the present invention is manufactured through a shape forming step (500), a coating preparing step (600), a coating step (700), and a stress removal heat treating step (800), which are sequentially carried out.

In the shape forming step (500), a metal plate made of stainless steel or spring steel has a shape of a pad spring 40 through pressing and bending processes. In the coating preparing step (600), both surfaces of the pad spring 40 are sanded or corroded such that both the surfaces of the pad spring 40 can be effectively coated with the low frictional material 50 and the elastic material 60. In the coating step (700), both the surfaces of the sanded or corroded pad spring 40 are coated with the low frictional material 50 and the elastic material 60.

Here, Teflon is employed as the low frictional material 50 and heat resistant reinforced rubber and Urethane are employed as the elastic material 60 so as to be able to stand heat of a high temperature in the stress removal heat treating step (800), which will be described later. In the coating step (700), in order to prevent the thickness of the metal plate from excessively increasing, the low frictional material 50 and the elastic material 60 are coated onto the surfaces of the pad spring 40 so as to respectively form thin films having a small thickness. Preferably, the low frictional material 50 has a thickness of 15˜25 μm, and the elastic material 60 has a thickness of 25˜35 μm. Here, the pad spring 40 maintains a thickness of approximately 0.3˜0.5 μm.

Preferably, Teflon employed as the low frictional member 50 is coated onto one surface of the pad spring 40 by spraying. However, Teflon may be coated onto the surface of the pad spring 40 by electrostatic painting or general painting. Further, the elastic material 60 includes a mixture obtained by adding designated amounts of carbon black, a vulcanization accelerator, an antioxidant, and a fluorine polymer to a synthetic resin including heat resistant reinforced rubber and Urethane, and is coated onto the other surface of the pad spring 40 by spraying.

In the coating step (700), the outer surface of the pad spring 40 to be coated with the elastic material 60 is preheated before the elastic material 60 is coated onto the surface of the pad spring 40. Thereby, the elastic material 60 is more effectively coated onto the surface of the pad spring 40, which was bent already through the bending process in the shape forming step (500).

Here, carbon black serves to increase the heat-resisting property of the elastic material 60 together with the heat resistant reinforced rubber and Urethane, the vulcanization accelerator and the antioxidant serve to increase the elastic force of the heat resistant reinforced rubber and suppress the oxidation of the elastic material 60, and the fluorine polymer serves to accelerate the reaction therebetween.//

Stress is concentrated on bending regions, such as the first and second supporting parts 41 and 42, during n the bending process of the shape forming step (500). Thus, in the stress removal heat treating step (800), the pad spring 40, went through the coating step (700), goes through a heat treatment process, i.e., annealing, at a temperature of 350˜370° C. such that the stress applied in the shape forming step (500) can be removed. Thereby, the manufacture of the pad spring 40 in accordance with the second embodiment is completed. Thus, although the stress applied to the pad spring 40 in the shape forming step (500) is removed in the stress removal heat treating step (800), which is carried out after the coating step (700), the low frictional material 50 and the elastic material 60, which are coated on the outer surfaces of the pad spring 40 to small thicknesses in the coating step (700), is not greatly affected by heat of a high temperature in the stress removal heat treating step (800).

As apparent from the above description, the present invention provides a pad spring of a disc brake, in which one surface of the pad spring contacting pad plates is coated with a low frictional material and the other surface of the pad spring contacting a carrier is coated with an elastic material, and a method for manufacturing the pad spring. The pad spring guides the sliding motion of the pad plates and reduces vibration transmitted from the pad plates to the carrier concurrently, and continuously maintains these functions, such as the friction reducing function and the damping function, for a long time.

Although embodiments of the invention have been shown and described, it would be appreciated by those skilled in the art that changes may be made in these embodiments without departing from the principles and spirit of the invention, the scope of which is defined in the claims and their equivalents.

What is claimed is:

1. A pad spring of a disc brake, in which a pair of pad plates sliding towards a disc is accommodated in a carrier fixed to a vehicle frame such that friction pads are respectively attached to the facing inner surfaces of the pad plates so as to press both surfaces of the disc rotated together with the rotation of a wheel and thus fix the disc, and pad springs for guiding the sliding motion of the pad plates and preventing vibration applied to the pad plates from being transmitted to the carrier are interposed among the pad plates and the carrier,
wherein one surface of the pad spring contacting the pad plates is coated with a low frictional material and the other surface of the pad spring contacting the carrier is coated with an elastic material.

2. The pad spring according to claim 1, wherein the low frictional material includes Teflon.

3. The pad spring according to claim 2, wherein the low frictional material coated onto the surface of the pad spring forms a thin film having a thickness of 15˜25 μm.

4. The pad spring according to claim 1, wherein the elastic material includes heat resistant reinforced rubber.

5. The pad spring according to claim 4, wherein the elastic material includes a synthetic resin, including the heat resistant reinforced rubber and Urethane, carbon black, a vulcanization accelerator, an antioxidant, and a fluorine polymer.

6. The pad spring according to claim 4, wherein the low frictional material coated onto the surface of the pad spring forms a thin film having a thickness of 25˜35 μm.

7. A method for manufacturing a pad spring of a disc brake comprising:
sanding or corroding both surfaces of a metal plate for forming the pad spring;
coating one surface of the sanded or corroded metal plate with a low frictional material and the other surface of the sanded or corroded metal plate with an elastic material;
processing the metal plate, coated with the low frictional material and the elastic material, by pressing and bending so as to form a shape of the pad spring; and
removing stress, applied to bending regions of the pad spring during the processing of the metal plate, by heat treatment.

8. The method according to claim 7, wherein:
the low frictional material includes Teflon and the elastic material includes heat resistant reinforced rubber;
the low frictional material and the elastic materials coated onto both surfaces of the metal plate respectively form thin films having thicknesses of 15˜25 μm and 25˜35 μm during the coating of the surfaces of the metal plate.

9. A method for manufacturing a pad spring of a disc brake comprising:
processing a metal plate by pressing and bending so as to form a shape of the pad spring;
sanding or corroding both surfaces of the pad spring;
coating one surface of the sanded or corroded pad spring with a low frictional material and the other surface of the sanded or corroded pad spring with an elastic material; and
removing stress, applied to bending regions of the pad spring during the processing of the metal plate, by heat treatment.

10. The method according to claim 9, wherein:
the low frictional material includes Teflon and the elastic material includes heat resistant reinforced rubber;
the low frictional material and the elastic materials coated onto both surfaces of the pad spring respectively form thin films having thicknesses of 15˜25 μm and 25˜35 μm during the coating of the surfaces of pad spring.
